(19) United States
(12) Patent Application Publication
(10) Pub. No.: US 2025/0386797 A1
(43) Pub. Date: Dec. 25, 2025

(54) Canine Drinking Bowl Device

(71) Applicant: Travis Amsbaugh, Marysville, OH (US)

(72) Inventor: Travis Amsbaugh, Marysville, OH (US)

(21) Appl. No.: 18/748,302

(22) Filed: Jun. 20, 2024

(51) Int. Cl. A01K 7/00; A46B 9/02

(52) U.S. Cl. CPC A01K 7/005

(57) ABSTRACT

A canine drinking bowl device for cleaning slobber from a canine's snout when the canine drinks water includes a bowl for containing water. The bowl has a volume of at least 1.0 liters to contain enough water to sustain a canine for at least 24.0 hours. A plurality of bristles is each attached to the bowl and the plurality of bristles is strategically oriented to define a drinking opening in the bowl. The canine o extends their snout through the drinking opening to drink the water in the bowl. The plurality of bristles scrubs slobber from the canine's snout when the canine lifts their snout out of the bowl thereby retaining the slobber in the bowl. Additionally, the plurality of bristles is oriented at an upward angle to resist poking the canine when the canine lifts their snout upwardly out of the bowl.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to canine drinking devices and more particularly pertains to a new canine drinking device for cleaning slobber from a canine's snout when the canine drinks water. The device includes a bowl for containing water and a plurality of bristles attached to the bowl. The bristles are arranged to define an opening through which a canine can extend its snout to drink the water in the bowl. The bristles scrub slobber from the canine's snout when the canine lifts their snout from the bowl thereby retaining the slobber in the bowl.

### (2) Description of Related Art Including Information Disclosed Under 37 CFR 1.97 and 1.98

The prior art relates to canine drinking devices including a variety of animal drinking bowl devices that each at least includes a bowl and a curved lip which curves into an interior of the bowl to inhibit water from splashing from the bowl and a plurality of animal drinking bowl devices that each at least includes a bowl for containing water and a plurality of bristles attached to perimeter wall of the bowl which are distributed over a full height and circumference of the perimeter wall for scrubbing slobber from a canine's snout when the canine drinks from the bowl. In no instance does the prior art disclose an animal drinking bowl device that includes a bowl for containing water and a plurality of bristles which are distributed in a single row around the bowl for wiping slobber from a canine's snout when the canine drinks from the bowl.

### BRIEF SUMMARY OF THE INVENTION

An embodiment of the disclosure meets the needs presented above by generally comprising a bowl for containing water. The bowl has a volume of at least 1.0 liters to contain enough water to sustain a canine for at least 24.0 hours. A plurality of bristles is each attached to the bowl and the plurality of bristles is strategically oriented to define a drinking opening in the bowl. The canine o extends their snout through the drinking opening to drink the water in the bowl. The plurality of bristles scrubs slobber from the canine's snout when the canine lifts their snout out of the bowl thereby retaining the slobber in the bowl. Additionally, the plurality of bristles is oriented at an upward angle to resist poking the canine when the canine lifts their snout upwardly out of the bowl.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a canine drinking bowl device according to an embodiment of the disclosure.

FIG. 2 is a front view of an embodiment of the disclosure.

FIG. 3 is a cross sectional view of an embodiment of the disclosure.

FIG. 4 is a perspective in-use view of an embodiment of the disclosure.

### DETAILED DESCRIPTION OF THE INVENTION

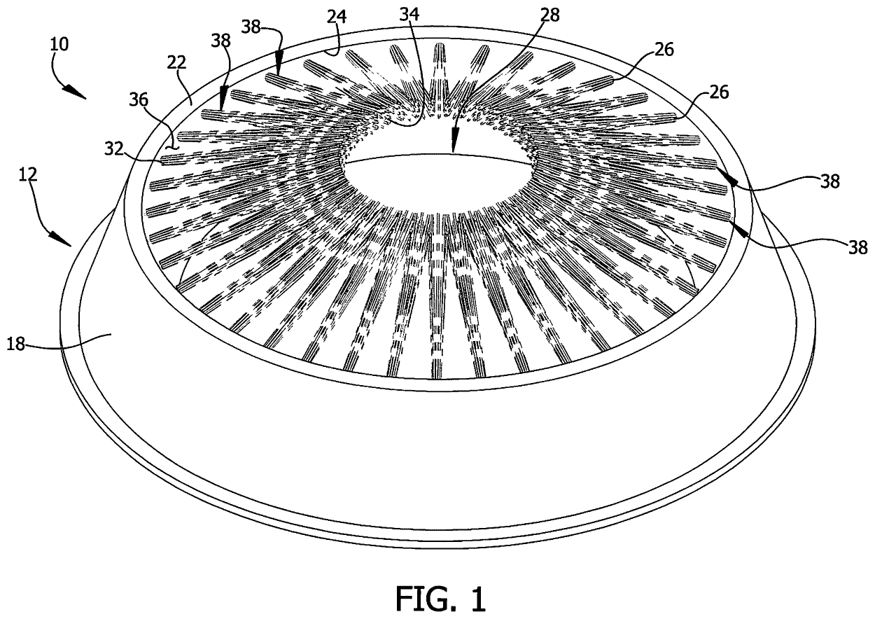

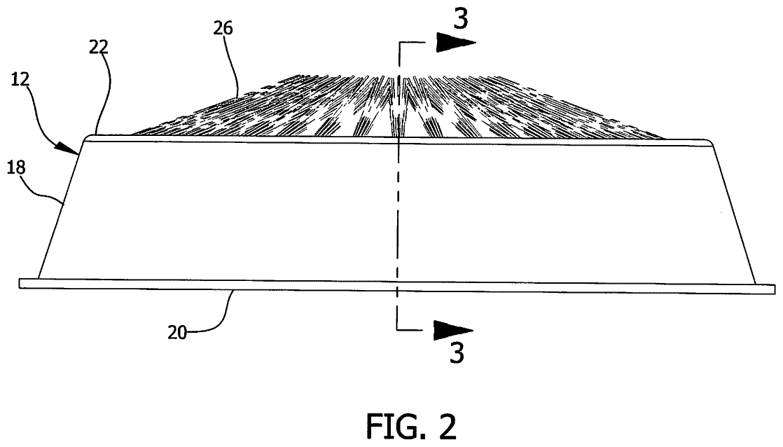

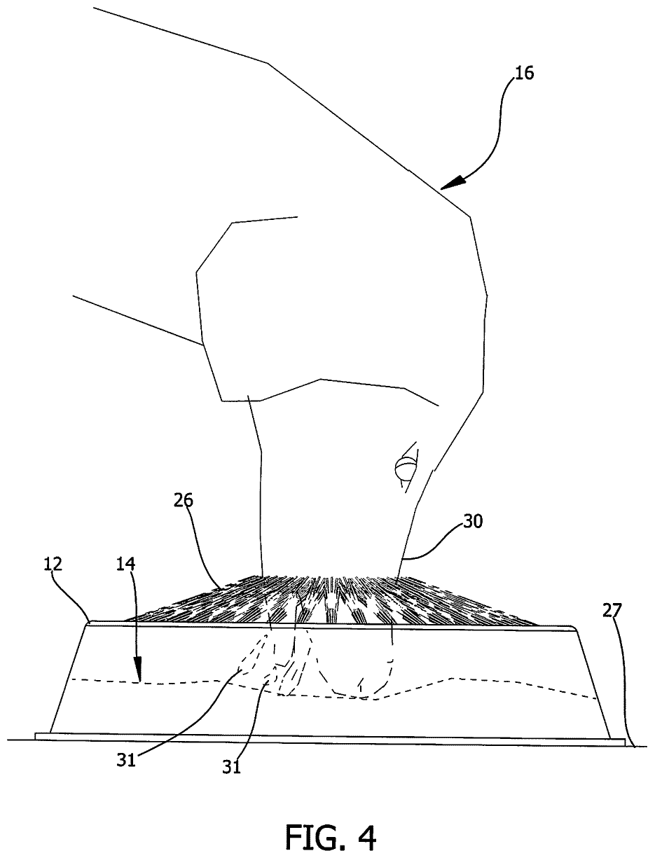

With reference now to the drawings, and in particular to FIGS. 1 through 4 thereof, a new canine drinking device embodying the principles and concepts of an embodiment of the disclosure and generally designated by the reference numeral 10 will be described.

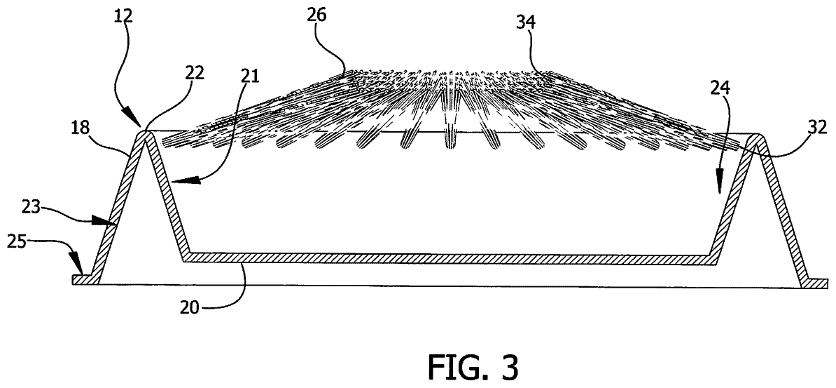

As best illustrated in FIGS. 1 through 4, the canine drinking bowl device 10 generally comprises a bowl 12 that is comprised of a fluid impermeable, including but not being limited to polyvinylchloride or metal, thereby enabling the bowl 12 to contain water 14. Additionally, the bowl 12 has an interior space which has a volume of at least 1.0 liters. In this way the bowl 12 can contain enough water 14 to sustain a canine 16 for at least 24.0 hours. The bowl 12 has a perimeter wall 18 extending upwardly from a basal wall 20 and the perimeter wall 18 angles inwardly between the basal wall 20 and a top edge 22 of the perimeter wall 18. Thus, an opening 24 defined by the top edge 22 has a diameter which is less than the diameter of the basal wall 20. In this way the bowl 12 is enabled to inhibit the water 14 from splashing outwardly through the opening 24. As is most clearly shown in FIG. 3, the perimeter wall 18 may comprise a first side 21 which extends upwardly from the basal wall 20 and a second side 23 oriented at an acute angle with the first side 21. Additionally the perimeter wall 18 may have a lip 25 which extends around a full circumference of the second side 23 such that the lip 25 rests on a support surface 27 having the basal wall 20 being elevated from the support surface 27.

A plurality of bristles 26 is provided and each of the plurality of bristles 26 is attached to the bowl 12. The bristles 26 are strategically oriented on the bowl 12 such that the plurality of bristles 26 defines a drinking opening 28 in the bowl 12. Furthermore, the drinking opening 28 enables the canine 16 to extend their snout 30 through the drinking opening 28 to drink the water 14 in the bowl 12. The plurality of bristles 26 is comprised of a resiliently bendable material, including but not being limited to rubber or plastic, thereby enabling the plurality of bristles 26 to scrub slobber 31 from the canine's snout 30 when the canine 16 lifts their snout 30 out of the bowl 12 thereby retaining the slobber 31 in the bowl 12. Furthermore, each of the bristles 26 is oriented at an upward angle on the bowl 12 thereby enabling the plurality of bristles 26 to resist poking the canine 16 when the canine 16 lifts their snout 30 upwardly out of the bowl 12.

Each of the plurality of bristles 26 has a coupled end 32 and a free end 34 and the coupled end 32 of each of the plurality of bristles 26 is coupled to an inwardly facing surface 36 of the perimeter wall 18 of the bowl 12 at a point which is located adjacent to the top edge 22 of the perimeter wall 18. Furthermore, the plurality of bristles 26 is distributed around a full circumference of the inwardly facing surface 36 of the perimeter wall 18 such that the free end 34 of each of the plurality of bristles 26 defines the drinking opening 28. Each of the plurality of bristles 26 is oriented at an angle on the inwardly facing surface 36 of the perimeter wall 18 such that each of the plurality of bristles 26 angles upwardly between the coupled end 32 and the free end 34. In this way the plurality of bristles 26 are enabled to efficiently scrub the slobber 31 from the canine's snout 30 when the canine 16 lifts their snout 30 upwardly out of the drinking opening 28. The plurality bristles 26 is arranged into a plurality of groups of bristles 38 and the plurality of groups of bristles 38 is evenly spaced apart from each other and is distributed around the circumference of the inwardly facing surface 36 of the perimeter wall 18.

In use, the canine 16 inserts their snout 30 through the drinking opening 28 defined by the bristles 26 to drink the water 14 in the bowl 12. The bristles 26 scrub slobber 31 from the canine's snout 30 when the canine 16 lifts their snout 30 outwardly from the drinking opening 28. In this way the slobber 31 is retained in the bowl 12 rather than dripping from the canine's snout 30 after the canine 16 lifts its snout 30 from the bowl 12. Thus, large breed dogs that commonly produce significant amount of slobber 31 when they drink water 14 can drink from the bowl 12 without tracking their slobber 31 around with them after they drink.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present. unless the context clearly requires that there be only one of the elements.

1. A canine drinking bowl device for wiping slobber from a canine's snout resulting from drinking water, said device comprising:
a bowl being comprised of a fluid impermeable material wherein said bowl is configured to contain water, said bowl having an interior space which has a volume of at least 1.0 liters wherein said bowl is configured to contain enough water to sustain a canine for at least 24.0 hours; and
a plurality of bristles, each of said plurality of bristles being attached to said bowl, said plurality of bristles being strategically oriented on said bowl such that said plurality of bristles defines a drinking opening in said bowl wherein said drinking opening is configured to enable the canine to extend their snout through said drinking opening to drink the water in said bowl, said plurality of bristles being comprised of a resiliently bendable material wherein said plurality of bristles is configured to scrub slobber from the canine's snout when the canine lifts their snout out of said bowl thereby retaining the slobber in said bowl, said plurality of bristles being oriented at an upward angle on said bowl when straight and unbent wherein said plurality of bristles is configured to resist poking the canine when the canine lifts their snout upwardly out of said bowl.

2. The device according to claim 1, wherein:
said bowl has a perimeter wall extending upwardly from a basal wall;
said perimeter wall angles outwardly from said basal wall to a top edge of said perimeter wall such that an opening defined by said top edge has a diameter which is greater than the diameter of said basal wall;
each of said plurality of bristles has a coupled end and a free end; and
said coupled end of each of said plurality of bristles being coupled to an inwardly facing surface of said perimeter wall of said bowl at a point being located adjacent to said top edge of said perimeter wall.

3. The device according to claim 2, wherein:
said plurality of bristles is distributed around a full circumference of said inwardly facing surface of said perimeter wall such that said free end of each of said plurality of bristles defines said drinking opening; and
each of said plurality of bristles is oriented at an angle on said inwardly facing surface of said perimeter wall such that each of said plurality of bristles angles upwardly between said coupled end and said free end wherein said plurality of bristles is configured to efficiently scrub the slobber from the canine's snout when the canine lifts their snout upwardly out of said drinking opening.

4. The device according to claim 2 wherein:
said plurality bristles is arranged into a plurality of groups of bristles; and
said plurality of groups of bristles is evenly spaced apart from each other and is distributed around said circumference of said inwardly facing surface of said perimeter wall.

5. A canine drinking bowl device for wiping slobber from a canine's snout resulting from drinking water, said device comprising:
a bowl being comprised of a fluid impermeable material wherein said bowl is configured to contain water, said bowl having an interior space which has a volume of at least 1.0 liters wherein said bowl is configured to contain enough water to sustain a canine for at least 24.0 hours, said bowl having a perimeter wall extending upwardly from a basal wall, said perimeter wall angling inwardly between outwardly from said basal wall to a top edge of said perimeter wall such that an opening defined by said top edge has a diameter which is greater than the diameter of said basal wall; and
a plurality of bristles, each of said plurality of bristles being attached to said bowl. said plurality of bristles being strategically oriented on said bowl such that said plurality of bristles defines a drinking opening in said bowl wherein said drinking opening is configured to enable the canine to extend their snout through said drinking opening to drink the water in said bowl, said plurality of bristles being comprised of a resiliently bendable material wherein said plurality of bristles is configured to scrub slobber from the canine's snout when the canine lifts their snout out of said bowl thereby retaining the slobber in said bowl, said plurality of bristles being oriented at an upward angle on said bowl when straight and unbent wherein said plurality of bristles is configured to resist poking the canine when the canine lifts their snout upwardly out of said bowl, each of said plurality of bristles having a coupled end and a free end, said coupled end of each of said plurality of bristles being coupled to an inwardly facing surface of said perimeter wall of said bowl at a point being located adjacent to said top edge of said perimeter wall, said plurality of bristles being distributed around a full circumference of said inwardly facing surface of said perimeter wall such that said free end of each of said plurality of bristles defines said drinking opening, each of said plurality of bristles being oriented at an angle on said inwardly facing surface of said perimeter wall such that each of said plurality of bristles angles upwardly between said coupled end and said free end wherein said plurality of bristles is configured to efficiently scrub the slobber from the canine's snout when the canine lifts their snout upwardly out of said drinking opening, said plurality bristles being arranged into a plurality of groups of bristles, said plurality of groups of bristles being evenly spaced apart from each other and being distributed around said circumference of said inwardly facing surface of said perimeter wall.
